(19) United States
(12) Patent Application Publication
(10) Pub. No.: US 2005/0044849 A1
(43) Pub. Date: Mar. 3, 2005

(54) Hydraulic control arrangement for a mobile work machine

(75) Inventors: Emmanuel Berthod, Arc les Gray (FR); Philippe Ostermann, Gray (FR)

Correspondence Address: Jimmie R. Oaks;DEERE & COMPANY, One John Deere Place, Moline, IL, 61265-8098, US

(73) Assignee: Deere & Company, a Delaware corporation

(21) Appl. No.: 10/913,233

(22) Filed: Aug. 6, 2004

(30) Foreign Application Priority Data
Aug. 9, 2003 (DE) 103 36 684.9

(51) Int. Cl. G05D 11/00

(52) U.S. Cl. 60/468

(57) ABSTRACT

A hydraulic control arrangement for a mobile work machine includes at least one hydraulic cylinder by means of which an operating tool can be moved. A direction control valve is provided for controlling the path of pressurized fluid between a pressure chamber of the cylinder, a pump, and a tank, as well as a safety valve inserted between the directional control valve and the pressure chamber of the cylinder to which pressure is applied during the lifting of the operating tool. The safety valve opens automatically when presssure is applied to the cylinder and is closed when no pressure is applied to the cylinder. The safety valve further operates so that it opens, automatically and independently of the pressure in the pressure chamber, during the lowering of the operating tool and/or during a float operating mode, selected by an operator.

### FIELD OF THE INVENTION

The invention concerns a hydraulic control arrangement for a mobile work machine with at least one hydraulic cylinder, by means of which an operating tool can be moved, a directional control valve for the control of the path of the pressurized medium between the pressure chamber of the cylinder, a source of pressurized medium and a tank, as well as a safety valve inserted between the directional control valve and the pressure chamber of the cylinder to which pressure is applied during the raising of the operating tool, which opens automatically when pressure is applied to the cylinder and is blocked when no pressure is applied to the cylinder.

### BACKGROUND OF THE INVENTION

Lifting gear arrangements, for example, front loaders, are attached to machines and used for lifting and transporting loads. They are provided with hydraulic cylinders for lifting the loads and, as a rule, also for pivoting the load, and are supplied with pressurized hydraulic fluid through removable, flexible hoses from a carrier machine. IN order to prevent the load-from being dropped in case of a hose break or failure that leads to a drop in the pressure in the cylinder carrying the load, so-called safety valves or load holding valves are used (see DE 100 06 908 A). These valves block the connection between the cylinder and the hose, as long as the operator does not initiate a movement of the lifting gear.

When the load is raised, a check valve in the safety valve opens, that permits filling of the pressure chamber. During the lowering, the safety valve opens as a function of the pressure difference between the secured pressure chamber of the double-acting cylinder and each of the other pressure chambers. Such safety valves are particularly on lifting gear of excavators, earth moving machines, fork lifts and agricultural loaders.

The subsequently published DE 102 27 966 proposes a different hydraulic control arrangement in which one hydraulic cylinder is associated with a first safety valve that can be brought into an open position by remote control from an operator. A second safety valve is opened by the pressure difference between the two pressure chambers of the double-acting cylinder when the operating tool is lowered.

With these safety valves, the disadvantage is seen in that the lowering movement is not always performed smoothly and without jerks, if two or more cylinders are provided that together perform a single movement. The safety valves associated with the individual cylinders frequently have different response sensitivities so that they do not open synchronously upon the lowering of the operating tool, which has the result that the cylinders are not lowered synchronously and the operating tool oscillates or shakes during the lowering. Moreover, thereby differing flow velocities in turn result in differing pressure differences at the safety valves that further increase the non-synchronous movement.

An operation in the floating move, in which the chambers of a double-acting hydraulic cylinder are connected to each other so as to conduct fluid, is not possible with the known safety valves, since they are always blocked when the cylinder is not being repositioned. For this purpose, DE 100 06 908 A provides a second valve which, however, increases the cost and the risk of a line failure.

The task underlying the invention is seen in the need to make available a hydraulic control arrangement that does not exhibit the aforementioned disadvantages or does so to a lesser degree.

### SUMMARY OF THE INVENTION

According to the present invention, there is provided an improved safety arrangement for use in the hydraulic circuitry of a lifting device.

An object of the invention is to provide such a hydraulic circuitry with a safety valve that reaches an open position automatically and independently of the pressure in the pressure chamber of a lifting cylinder when the operating tool is lowered and/or when a float operating mode is selected by an operator. Thereby, the pressure in the pressure chamber, which is emptied during the lowering of the operating tool, is not considered, so that any pressure differences in the pressure chambers of two cylinders moved synchronously cannot become detrimental. Furthermore the opening of the safety valve is performed without any effect from environmental conditions, such as the viscosity, the temperature and the rate of flow of the hydraulic fluid. The open safety valve does not impair the hydraulic operation of the lifting gear by undesirable flow resistances, since in its open position the safety valve can be provided with a sufficiently large flow opening.

As an alternative, or in addition, it s proposed that the safety valve open automatically if the operator has selected a float operating move. Then the operating tool, as a rule, is lowered and lies upon the ground or on another support surface, although it would be conceivable to activate this mode of operation for special applications even with a raised operating tool. Thereby the pressure in the pressure chamber of the hydraulic cylinder is preferably not considered in the control of the safety valve, although embodiments would also be conceivable in which it is considered. An advantage lies in the fact that in this way a floating operating move becomes possible, for example, for surface copying in which the pressure chamber is loaded for the raising of the operating tool and it as well as a second chamber of the double-acting cylinder are connected to each other over the directional control valve that is brought into a float position and the safety valve now opened. As a rule, they are also connected to the tank.

There are various possibilities for the control of the safety valve. In a first embodiment, pressurized medium is applied to a second pressure chamber of a double-acting cylinder during the lowering. On the basis of this pressure, the safety valve can be controlled and opened, if necessary, whereupon the pressure either directly actuates the safety valve by means of a control cylinder or indirectly in which it is detected by a pressure sensor, for example, a pressure switch, whose output signal is used for the electromagnetic or hydraulic control of the safety valve.

In another embodiment, the safety valve is controlled electromagnetically or hydraulically on the basis of an input from the operator. The operator input can be detected directly, for example, by a switch contact at an operator input arrangement, or indirectly in which the position of an element influenced by the operator input arrangement is detected, for example, the directional control valve. In this embodiment, single-acting or double-acting cylinders can be applied. Combinations of a hydraulic and electromagnetic detection of the operating mode are also possible as is a control arrangement of the safety valve based on these. In this way, the lifting and holding operating mode can be detected hydraulically and the lowering and float operating mode can be detected on the basis of operator input.

As already noted above, two or more cylinders are provided on most lifting gear arrangements, that are moved synchronously for the movement of the operating tool.

an obvious solution is to equip the pressure chamber of each of these cylinders, to which pressure is applied during the lifting of the operating tool, with a safety valve according to the invention. alternatively, only a single safety valve is applied, that is connected with the pressure chambers of the cylinders. To avoid possible hose failures and the safety risks associated with these, this connection is preferably performed by mechanically rigid line elements, particularly tubes.

### BRIEF DESCRIPTION OF THE DRAWINGS

The drawings show five embodiments of the invention that shall be described in greater detail in the following.

FIG. 1 is a left side view of a lifting gear arrangement with an operating tool.

FIG. 2 is a hydraulic circuit schematic of a first embodiment of a control arrangement according to the invention, that includes two cylinders and a hydraulically controlled safety valves.

FIG. 3 is a hydraulic circuit schematic of a second embodiment of a control arrangement according to the invention, that includes two cylinders and two hydraulically controlled safety valves.

FIG. 4 is a hydraulic circuit schematic of a third embodiment of a control arrangement according to the invention, that includes two cylinders and two electromagnetically controlled safety valves.

FIG. 5 is a hydraulic circuit schematic of a fourth embodiment of a control arrangement according to the invention, that includes two cylinders and an electromagnetically controlled safety valve.

FIGS. 6a and 6b show arrangements for the detection of the position of an operator input arrangement that is used for the control of the electromagnetically controlled safety valves.

FIG. 7 shows an arrangement for the detection of the position of a directional control valve that is used for the control of the electromagnetically controlled safety valves.

FIG. 8 is a hydraulic circuit schematic for a control circuit for the control of the electromagnetically controlled safety valves.

FIG. 9 is a hydraulic circuit schematic of a fifth embodiment of a control arrangement according to the invention, that includes two cylinders and two electromagnetically controlled safety valves, that are controlled on the basis of the pressure in the second pressure chamber of the cylinder.

### DESCRIPTION OF THE PREFERRED EMBODIMENT

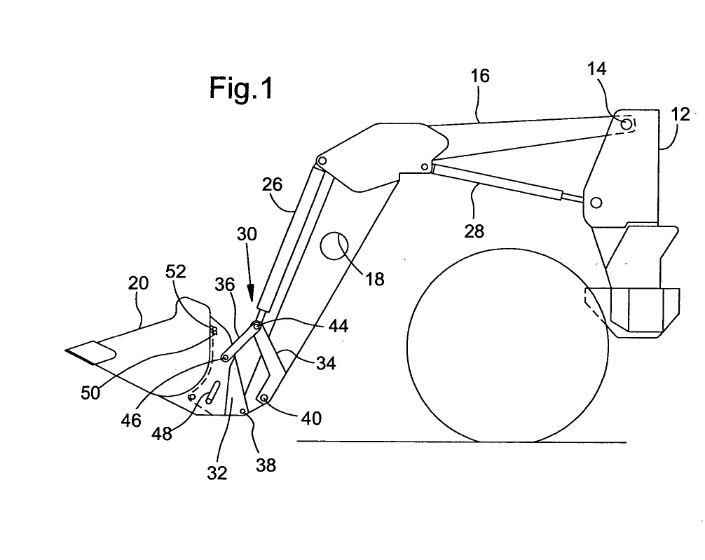

The hydraulic control arrangement according to the invention is explained on the basis of an example of a tractor with a front loader. However, it can be used on any desired operating machine with movable operating tools, such as wheel loaders, telescopic loaders, excavators and the like. A lifting gear 10 shown in FIG. 1 is attached to the front end of a tractor that is only partially indicated. The lifting gear 10 includes a mast 12 that is shown and that engages in a bearing 14 a lifting linkage 16 which includes parallel arms reinforced by a tube 18 that extends through and is welded to them.

An operating tool 20, here shown as a bucket, could, for example, be an earth shovel, a manure fork or a pallet fork, is connected free to pivot and interchangeable, to the front end of the lifting linkage 16 by means of a repositioning arrangement 30 and a tool holder 32. In order to lift the operating tool 20, the lifting linkage 16 is pivoted about the bearing 14 by two hydraulic cylinders 28. Further hydraulic cylinders 26 are located at opposite sides of the lifting linkage 16 and each engages with one end the repositioning arrangement 30 and with its other end the lifting linkage 16 for the repositioning of the inclination of the operating tool 20. The repositioning arrangement 30 operates on the tool holder 32, to which the operating tool 20 is connected directly, and is composed generally of a first and a second pivot arm 34 and 36, which are connected with each other in a joint, where the joint 44 engages the cylinder 26.

The tool holder 32 is supported in a bearing 38 and the first pivot arm 34 is supported in a bearing 40, both on the lifting linkage 16, free to pivot. The second pivot arm 36 is connected, free to pivot, with the tool holder 32 in a bearing 46. The part number call-out 48 indicates a locking bar for the retention in a detent of the tool 20. In the upper section of the tool holder 32, a hook 50 and a pin 52 are provided, that bring the tool 20 into engagement with the lifting gear 10.

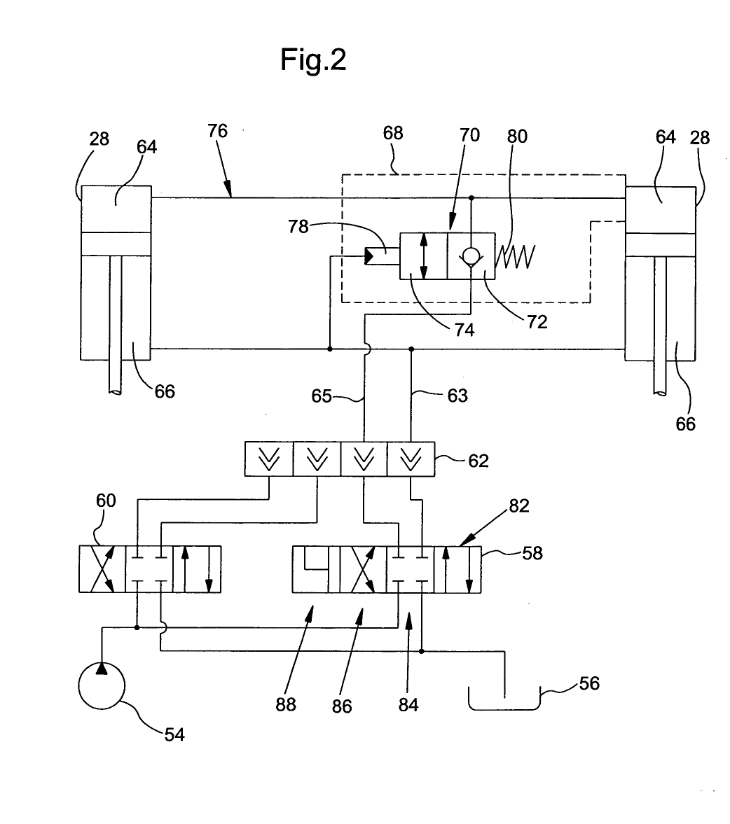

FIG. 2 shows a schematic of the hydraulic control arrangement according to the invention for the operating machine of FIG. 1. A pump 54 is provided as a pressurized fluid source, and a tank 56 for the collection of spent pressurized fluid are arranged on the tractor. The pump 54 is connected to two direction control valves 60 and 62, respectively, which are in turn coupled to a hydraulic coupling 62. The direction control valves 58 and 60 can be actuated by an operator from the cab of the tractor. The hydraulic connections of the lifting gear 10 are connected to the removable coupling 62. The double-acting cylinders 62 are connected over the coupling 62 directly with the directional control valve 60, so that the operating tool 20 can be pivoted in a manner known in itself by actuation of the directional control valve 60.

The cylinders 28 are double-acting. They are connected over flexible hoses 63 and 65 and the coupling 62 with the directional control valve 58. Pressure is applied to its head end pressure chamber 64 in order to pivot the lifting linkage 16 upward with the operating tool 20. Analogously, pressure is applied to its rod end chamber 66 when the lifting linkage 16 with the operating tool 20 is to be pivoted downward. In order to prevent an undesired downward sinking of the operating tool 20 in case a flexible hose 63, coupled between the coupling 62 and the rod end chambers 66, should fail, a safety valve block 68 is provided in a line 65 coupled between the coupling 62 and the head end chambers 64 of the hydraulic cylinders 28. The safety valve block 68 is provided with two connections respectively coupled to the head end chambers 64 of the two hydraulic cylinders 28. The safety valve block 68 is fastened directly to the cylinder 28, shown at the right in FIG. 2. The cylinder 28 shown t the left in FIG. 2 is spaced away from t safety valve block 68 and is connected to it by a rigid line 76.

The safety valve block 68 contains a safety valve 70. The safety valve 70 includes a check valve 72 that opens when the pressure in the head end chamber 64 is lower than the pressure in the associated connection of the coupling 62. Thereby it opens automatically when the operator raises the pressure in the head end chamber 64 by actuating the direction control valve 58. The safety valve 70 can be brought from the position shown in FIG. 2, in which the check valve 72 is inserted between the associated connection on the coupling 62 and the head end chambers 64, into a second position in which the check valve 72 is replaced by a through flow opening 74. The safety valve 70 is preloaded by a spring 80 into the position shown in FIG. 2. It is moved between the two aforementioned positions by means of a control cylinder 78, whose head end chamber is connected with the rod end chambers 66 of the cylinders 28 so as to conduct pressurized medium.

The method of operation of the control arrangement shown in FIG. 2 is as follows:

If the direction control valve 58 is brought into the lifting position 82, then the head end chambers 64 of each cylinder 28 is filled with hydraulic fluid from the pump 54 over the direction control valve 58, the coupling 62, the hose 65 and the check valve 72, which opens. Simultaneously, hydraulic fluid is drained off from the rod end chambers 66 over the hose 63, the coupling 62 and the direction control valve 58 into the tank 56. The pressure in the hose 63 is not sufficient to move the safety valve 70, by means of the control cylinder 78 against the force of the spring 80, out of the position shown in FIG. 2.

In the holding position 84, the hoses 63 and 65 are blocked by the direction control valve 58, so that no pressurized medium can flow out of the chambers 64 and 66 and the operating tool 20 remains at a selected height. Here the safety valve 70 also remains in the position shown in FIG. 2.

In the lowering position 86, the pump 54 is connected by the direction control valve 58 with the rod end chambers 66 of each of the cylinders 28. The control cylinder 78 is also moved by the increasing pressure in the hose 63 and it moves the safety valve 70 against the force of the sprig 80 out of the position shown in FIG. 2 into the through flow position in which the through flow opening 74 replaces the check valve 72 and makes it possible for the pressurized medium to drain off out of the head end chamber 64 through the hose 65 into the tank 56. Thereby the operating tool 20 moves downward.

In those cases in which a safety risk exists, that is, in the lifting position 82 and in the holding position 84, the safety valve 70 is active so that the check valve 72 is inserted between the head end chamber 64 and the hose 65. Thereby a possible failure of the hose 65 does not lead to an undesired lowering of the operating tool 20. On the other hand, in the lowering position 86, the assumption can be made that no person is located under the operating tool 20, so that then a securing of the hose 65 against failure is not necessary. In the through flow position of the safety valve 70, relatively high rates of fluid flow are possible so that the operating tool 20 can be lowered quite rapidly.

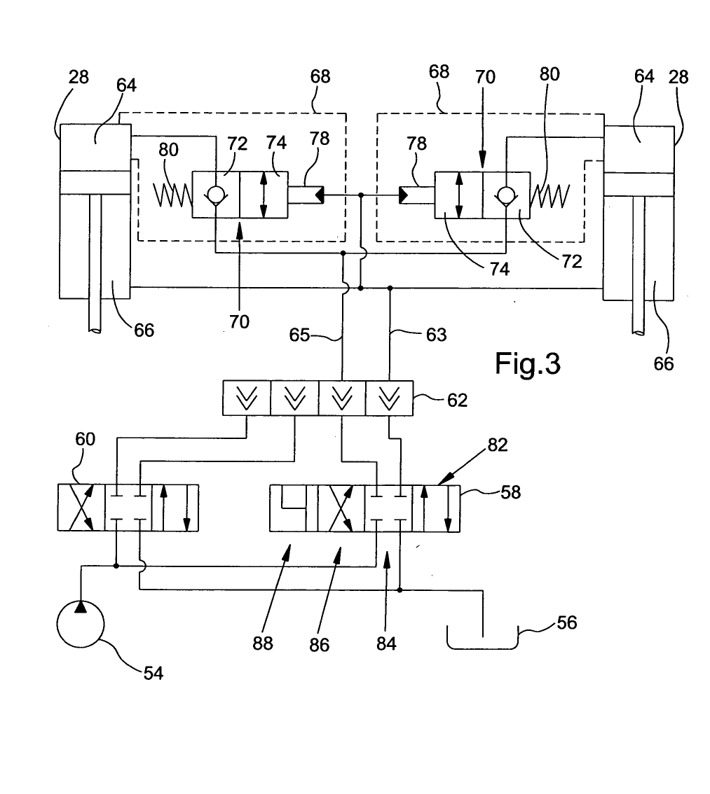

A second embodiment of a control arrangement according to the invention is shown in FIG. 3, whose configuration and method of operation generally corresponds to that of FIG. 2. Elements corresponding to the first embodiment are indicated by the same number call-outs. The second embodiment differs from the first embodiment in the fact that each cylinder 28 is associated with a safety valve 70. In this embodiment, it is particularly noticeable to great advantage that the switching of the safety valve 70 into the through flow position can be performed independently of the pressure in the head end chambers 64, so that different movements of the two cylinders 28 during the lowering, that lead to shaking of the operating tool 20, are not to be feared.

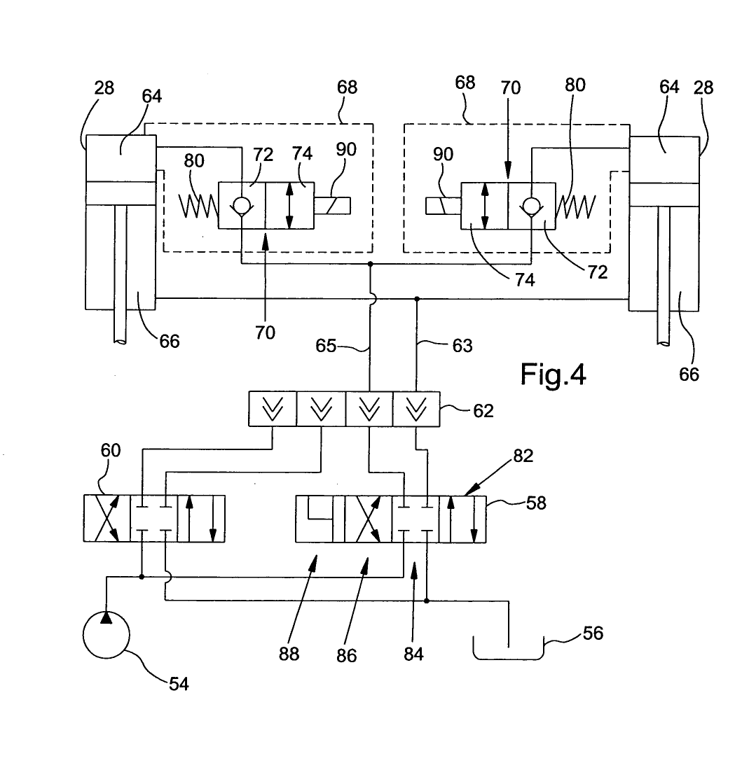

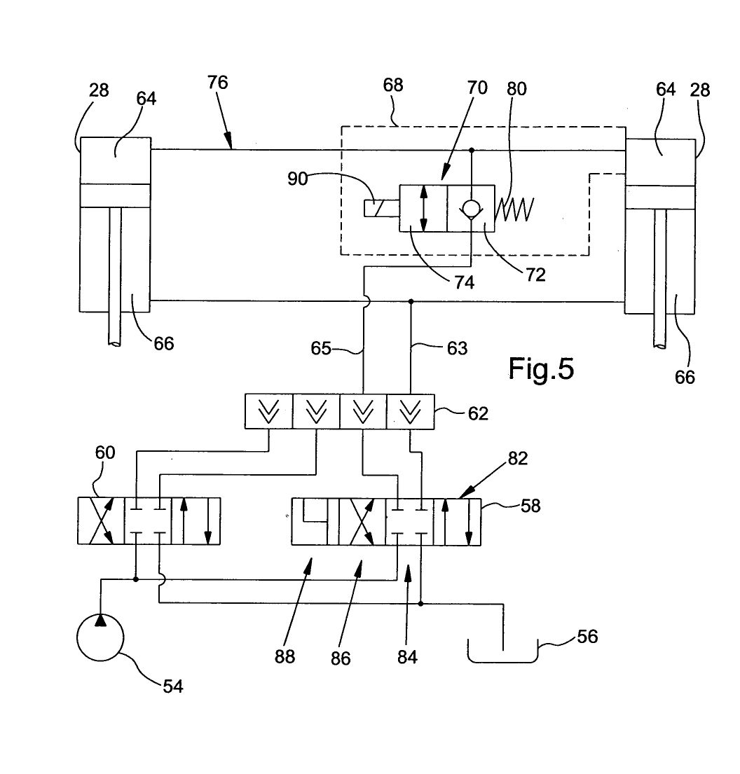

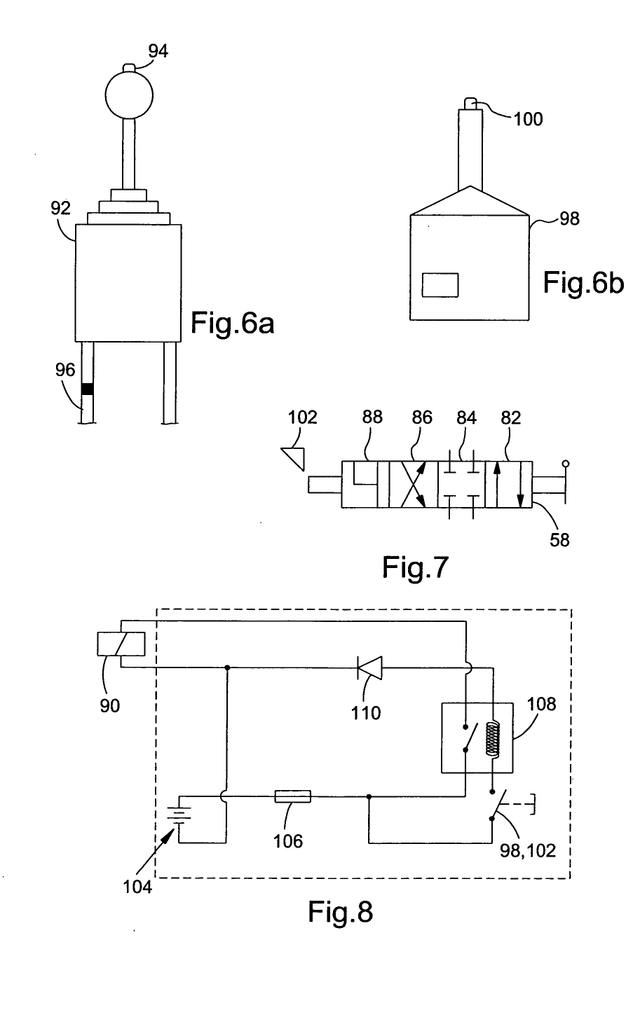

FIG. 4 shows a third embodiment of a control arrangement according to the invention. Elements corresponding to the first embodiment are identified by the same part number call-outs. In contrast to the first two embodiments described above, the safety valve 70 is not actuated hydraulically here, but electromagnetically. For this purpose, an electromagnetic actuator 90 is connected to the safety valve 70. The actuator 90 may be coupled with the direction control valve 58 or with an operator input arrangement and brings the safety valve 70 into the position, in which the through flow opening 74 is located between the head end chamber 64 and the hose 65, when the directional control valve 58 is in the lowering position 86 or in a float position 88. On the other hand, if the direction control valve 58 is in the lifting position 82 or in the holding position 84, then the actuator 90 is deactivated and the spring 80 brings the safety valve 70 into the position in which the check valve 72 is arranged between the hose 65 and the head end chamber 64. Thereby the same function is attained as in the first and second embodiments. The control of the actuator 90 is described below on the basis of FIGS. 6 through 8.

In the embodiment according to FIG. 4, the direction control valve 58 can be brought, in addition, into a float position 88. There the hoses 63 and 65 are connected to each other and to the tank 56. The control cylinder 78 is controlled in such a way that the safety valve 70 is also brought into the through flow position or remains in that position, so that the float movement of the cylinder 28 becomes possible. This float position 88 makes it possible to let the operating tool 20 lie upon the ground with a constant force which makes it possible, for example, during the removal of manure from stalls, or the harvesting off of a field with a beet harvesting device, to follow the contours of the ground automatically. The configuration of the safety valve 70 according to the invention makes it possible to select a float operating mode without any additional valves.

FIG. 5 shows a fourth embodiment of a control arrangement according to the invention whose configuration and function corresponds generally to that of FIG. 4. Elements corresponding to the embodiments described previously are identified with the same part number call-outs. The difference from the configuration according to FIG. 4 consists of the fact that only a single safety valve 70 is provided, that is fastened directly to one of the cylinders 28 and whose outlet is connected to the other cylinder 28 by a rigid line.

The FIGS. 6a through 8 show configurations of arrangements for the control of the electromagnetic actuator 90, that can be used in the embodiments according to FIGS. 4 and 5. In the embodiment according to FIG. 6a, an operating element 92 is provided with a series of cables 96 that are provided for the electromagnetic control of the direction control valve 58, the operating element is in the form of a so-called joystick, that is used for the control of the direction control valve 58 that is provided with a handgrip 94 on its upper side that can be handled by an operator in the cab of the tractor. The actuator 90 is controlled by means of an appropriate electronic control on the basis of the voltages applied to the cables 96. According to FIG. 6b, an independent switch 98 can also be arranged in the cab, it is equipped with a hand grip 100 that is used for the control of the actuator 90.

The embodiment according to FIG. 7 uses a switch 102 that is actuated mechanically by the direction control valve 58. If the direction control valve 58 is located in one of the positions 86 or 88, then the switch 102 is turned on, which in turn activates the actuator 90. On the other hand, if the direction control valve 58 is located in the position 82 or 84, then the switch 102 and the actuator 90 are turned off.

According to FIG. 8, the switches 98 or 102 can operate the actuator 90 by means of a control arrangement that is provided with a battery 104, a fuse 106 and a relay 108 as well as a spark extinguishing diode 110. If the switch 98 or 102 is closed, then a current flows through the coils of the relay 108, over the fuse 106 and the spark extinguishing diode 110 so that the switch attracts the relay 108 and the actuator 90 is activated which is also supplied by the a battery 104, which, as a rule, is the battery of the tractor. When the switches 98 and 102 are opened, the spark extinguishing diode 110 prevents undesired sparks at the switches 98 and 102, the spark extinguishing diode could also be switched parallel to the coil of the relay 108 as an anti-parallel diode.

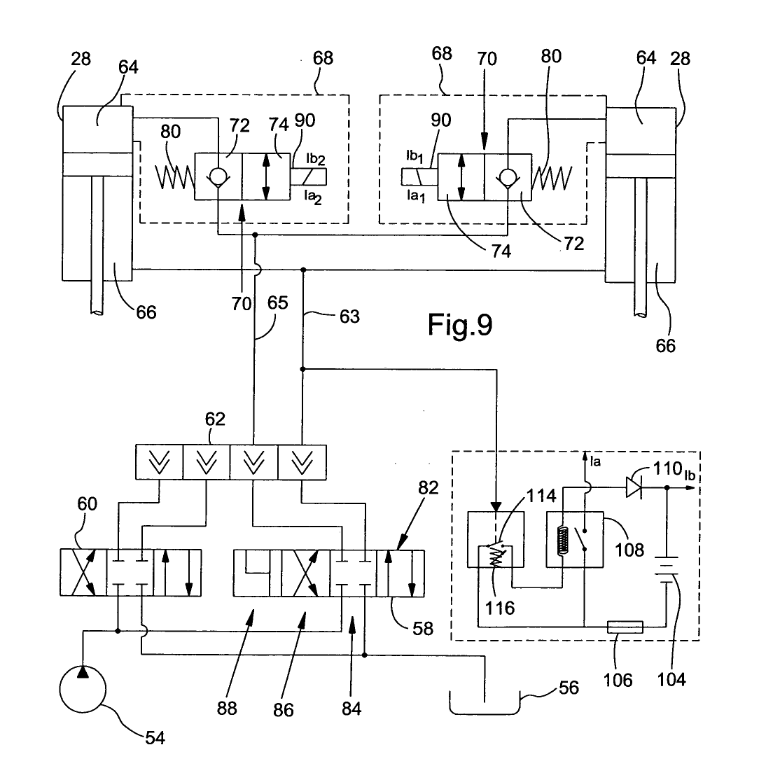

Finally, FIG. 9 shows a fifth embodiment of a control arrangement that corresponds generally in configuration and function to the control arrangement of the embodiment of FIG. 4. Elements corresponding to the embodiment according to FIG. 4 are identified with the same part number call-outs. However, the control of the safety valves 70 is performed by a hybrid hydraulic/electromagnetic control arrangement. There the hose 63, that is connected with the rod end chambers 66, is connected with a pressure switch 112. The pressure switch 112 contains a switch contact 114 that switches on or off at a pressure in the hose 63 which can be adjusted by means of an adjustable spring 116. Analogously to the switching arrangement of FIG. 8, the switch contacts 114 are connected over a fuse 106, the coils of a relay 108 and a spark extinguishing diode 110 with a battery 104, which as a rule, is also the battery of the tractor. The actuator 90 of the safety valve 70 is controlled by the switch contacts of the relay 108.

The method of operation of the control arrangement according to FIG. 9 corresponds to the embodiments according to FIGS. 2 and 3. Specifically, if the direction control valve 58 is in the lifting position 82 or in the holding position 84, a relatively low pressure is applied to the pressure switch 112, which is not sufficient to close the switch contact 114 against the force of the spring 116. Therefore, the relay 108 is not energized, so that no current is applied to the actuators 90 either. The safety valves 70 remain in the position shown in FIG. 9, I which the check valves 72 are located between the hose 65 and the head end chambers 64. ON the other hand, if the direction control valve 58 is brought into the lowering position 86, the pressure applied to the pressure switch 112 increases, so that the switch contact 114 closes against the force of the spring 116. Thereby current flows from the battery 104 through the fuse 106, the switch contact 114, the coil of the relay 108 and the spark extinguishing diode 110. The relay 108 is energized and supplies current to the actuators 90, so that these bring the safety valves 70 into the position in which the through flow opening 74 is positioned between the head end chamber 64 and the hose 65. Thereby hydraulic fluid can drain out of the head end chambers 64 and the operating tool 20 is lowered.

In order to also perform a float operating mode, it would be conceivable in the embodiment according to FIG. 9, and in the embodiments according to FIGS. 2 and 3, to provide in addition a recognition of the float position 88 of the direction control valve 58 by means of a switch, analogous to FIG. 7, and a corresponding electromagnetic actuation of the safety valve 70.

In the embodiment according to FIG. 9, a single safety valve 70 could also be provided and connected to both cylinders 28, analogously to the embodiments according to FIGS. 2 and 5. Moreover, the pressure switch 114 could be arranged on the side of the coupling 62 facing the tractor, where a plug-in or a wireless connection, such as a radio, optical, etc., with the safety valve 70 could be provided.

It should be noted that in embodiments in which pressure is applied to the rod end chamber 66 for the lifting of the operating tool 20, it is appropriate to secure the rod end chamber 66 in place of head end chamber 64 by means of safety valves 70. Furthermore, in place of or in addition to the cylinders 28, the cylinder or cylinders 26 could also be blocked in the manner shown by a safety valve 70. Here the rod end chamber should be equipped with a safety valve 70.

Having described the preferred embodiment, it will become apparent that various modifications can be made without departing from the scope of the invention as defined in the accompanying claims.

1. In a combination including a mobile operating machine including a linkage mounted at one end to a support for pivoting vertically about a transverse axis and carrying an operating tool at an opposite end, at least one hydraulic cylinder coupled between the support and the linkage by means of which the operating tool can be moved by directing pressurized fluid into a pressure chamber of said cylinder, a direction control valve coupled to the hydraulic cylinder and to a source of pressurize fluid and to a tank for respectively controlling the path of pressurized fluid between said pressure chamber and said source of fluid pressure and said tank, and a safety valve inserted between the direction control valve and said pressure chamber and operable for automatically moving to an open position when pressure is directed to said pressure chamber by operation of said direction control valve, the improvement comprising; said safety valve being operable for being moved to said open position independently of pressure in said pressure chamber when said operating tool is lowered and/or in response to an operator placing said direction control valve in a float position wherein said pressure chamber is connected to said tank.

2. The combination, as defined in claim 1, wherein said cylinder includes a second pressure chamber so as to be double-acting; and said float position of said directional control valve being such as to be connected to said pressure chamber, by way of said safety valve when the latter is open, to be connected to said second pressure chamber and to couple said pressure chamber and second pressure chamber together and to said tank.

3. The combination, as defined in claim 2, wherein said safety valve is a normally closed and is opened by a hydraulic pressure; and said second pressure chamber being coupled to said safety valve for automatically opening the latter in response to pressure in said second pressure chamber.

4. The combination, as defined in claim 1, wherein said safety valve is a solenoid-operated valve which is remotely operable on the basis of an operator input.

5. The combination, as defined in claim 4, wherein an operator input arrangement is provided for controlling both said direction control valve and said safety valve such that said safety valve is moved out of its normally closed position only when said operator input arrangement is operated to place said direction control valve in a position for lowering said tool or for effecting float.

6. The combination, as defined in claim 1, wherein a second cylinder is provided between said support and linkage for working in concert with said cylinder for moving said tool; and a second safety valve being coupled between said second cylinder and said direction control valve in exactly the same way that said safety valve is coupled between said cylinder and said direction control valve.

7. The combination, as defined in claim 1, wherein a second cylinder is provided between said support and linkage for working in concert with said cylinder for moving said tool; and said safety valve being coupled to said second cylinder in exactly the same way that it is coupled to said cylinder.

8. The combination, as defined in claim 7, wherein a rigid line is used for coupling the pressure chamber of said second cylinder with said safety valve.

9. The combination, as defined in claim 8, wherein a flexible hose is used for connecting said safety valve to said direction control valve.
